(19) United States
(12) Patent Application Publication
(10) Pub. No.: US 2025/0368096 A1
(43) Pub. Date: Dec. 4, 2025

(54) MODULAR CARRIER ASSEMBLY FOR SWIVEL MECHANISM

(71) Applicant: Magna Seating Inc., Aurora (CA)

(72) Inventor: Louis Vetere, II, Commerce Township, MI (US)

(21) Appl. No.: 18/870,015

(22) PCT Filed: May 30, 2023
(86) PCT No.: PCT/US2023/023807

§ 371 Date: Nov. 27, 2024

Related U.S. Application Data
(60) Provisional application No. 63/346,340, filed on May 27, 2022.

(51) Int. Cl. B60N 2/14

(52) U.S. Cl. CPC B60N 2/143

(57) ABSTRACT

A seat assembly for an automotive vehicle has a seat base, a seat cushion, and a swivel mechanism. The swivel mechanism includes a lower plate fixedly coupled to the seat base by a structure attachment, an upper plate rotatably coupled to the lower plate, and a modular carrier assembly fixedly coupled to the upper plate and fixedly coupled to the seat cushion. The modular carrier assembly includes a tubular frame fixedly coupled to the upper plate. The tubular frame includes a front portion and a rear portion extending between a left portion and a right portion with the tubular frame surrounding around an opening extending vertically therethrough providing vertical access to lower attachment holes in the seat base.

### CROSS-REFERENCE TO RELATED APPLICATIONS

This application claims priority to U.S. Provisional Application 63/346,340. filed on May 27, 2022, the disclosure of which is hereby incorporated by reference in its entirety.

### FIELD AND BACKGROUND OF THE INVENTION

The present invention relates to a seat assembly for use in an automotive vehicle. More particularly, the invention relates to a modular carrier assembly for use in an automotive seat assembly having a swivel mechanism configured to allow rotation of the seat assembly between forward-facing and rearward-facing positions.

### DESCRIPTION OF RELATED ART

Automotive vehicles typically include one or more seat assemblies having a seat cushion and a seat back for supporting a passenger above a vehicle floor. It is commonly known for certain seat assemblies to be pivotable between a forward-facing position and a rearward-facing position. It is also commonly known for certain seat assemblies to include a swivel mechanism operatively coupled between the seat cushion and a seat base (such as riser brackets or a track assembly, as examples) and configured to allow rotation of the seat cushion between the forward-facing and rearward-facing positions. The swivel mechanism typically includes an upper plate rotatably coupled to a lower plate. Rollers and/or bearings are typically positioned between the upper and lower plates to allow for smooth rotation of the swivel mechanism. In addition, the lower plate is typically fastened to the seat base either by welding or by a plurality of mechanical fasteners extending through structure attachment holes in the lower plate.

Certain seat assemblies include one or more large brackets attached to the upper plate and fixedly coupled to other components of the seat assembly, such as a cushion frame, a back frame, reclining mechanisms, electric motors, control modules, and the like. Likewise, certain functional components, such as a latching mechanism, electric motors, control modules, and the like, may be fixedly coupled to the upper plate. In addition, modifications to certain swivel mechanisms may be required in order to add or remove functional components from the swivel mechanism for use in high content and low content seat assemblies.

In addition, certain seat assemblies include an upper stamping for seat integration. The upper stamping is fixedly coupled to the upper plate and the seat cushion. Certain upper stampings have a generally C-shape with a rear portion extending between opposing side portions. The side and rear portions surround a center opening and include a gap between the distal ends of the side portions. The upper stamping is typically fixedly coupled to the upper plate with the gap facing forward.

However, commonly known seat assemblies may require the swivel mechanism to be rotated to provide installation access to lower attachment holes in the seat base. In addition, different upper stampings may be required to assemble the upper plate to a variety of seat cushions.

It is desirable, therefore, to provide access to the lower attachment holes in the seat base while the seat assembly is facing forward. In addition, it is desirable to improve the assembly of the swivel mechanism while providing a simplified environment to add, drop, and change functional components from the swivel mechanism for use in different seat assemblies. Further, it is desirable for the swivel mechanism to be customizable to mount to different seat cushions without requiring custom upper stampings.

### SUMMARY OF THE INVENTION

According to one embodiment, there is provided a seat assembly for an automotive vehicle. The seat assembly comprises a seat base, a seat cushion, and a swivel mechanism. The swivel mechanism includes a lower plate fixedly coupled to the seat base by a structure attachment, an upper plate rotatably coupled to the lower plate, and a modular carrier assembly fixedly coupled to the upper plate and fixedly coupled to the seat cushion. The modular carrier assembly includes a tubular frame fixedly coupled to the upper plate. The tubular frame includes a front portion and a rear portion extending between a left portion and a right portion with the tubular frame surrounding around an opening extending vertically therethrough providing vertical access to lower attachment holes in the seat base.

According to another embodiment, there is provided a modular carrier assembly for use in an automotive seat assembly having a swivel mechanism. The modular carrier assembly comprises a tubular frame including a front portion and a rear portion extending between a left portion and a right portion with the tubular frame surrounding an opening extending vertically therethrough. The modular carrier assembly also includes laterally spaced apart seat brackets fixedly coupled to the left portion and the right portion, respectively, of the tubular frame and a functional component fixedly coupled to the tubular frame.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a seat assembly including a seat cushion, a seat base, and a swivel mechanism pivotally coupled between the seat cushion and the seat base with the swivel mechanism including a modular carrier assembly, according to one embodiment of the present invention;

FIG. 2 is top view of the swivel mechanism and the seat base of FIG. 1 with the modular carrier assembly including a rotation motor and a release actuator, according to one embodiment of the present invention;

FIG. 3 is a perspective view of the swivel mechanism and the seat base of FIG. 2;

FIG. 4 is a perspective view of the modular carrier assembly of FIG. 3, according to one embodiment of the present invention;

FIG. 5 is a perspective view of the swivel mechanism and the seat base of FIG. 3, with the modular carrier assembly also including a heater module and a seat control module, according to another embodiment of the present invention; and

FIG. 6 is a perspective view of the swivel mechanism and the seat base of FIG. 5, with the modular carrier assembly including a manual release assembly, according to another embodiment of the present invention.

### DETAILED DESCRIPTION OF THE INVENTION

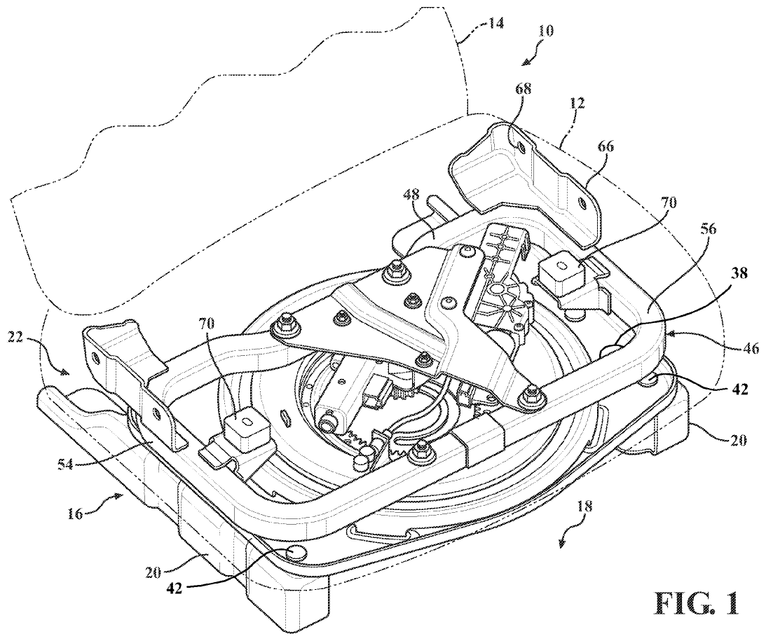

FIGS. 1-6 illustrate components of an automotive seat assembly 10 for use in an automotive vehicle according to embodiments described herein. Directional references employed or shown in the description, figures, or claims, such as top, bottom, upper, lower, upward, downward, lengthwise, widthwise, left, right, and the like, are relative terms employed for ease of description and are not intended to limit the scope of the invention in any respect. Referring to the Figures, like numerals indicate like or corresponding parts throughout the several views.

Depicted in FIG. 1, the seat assembly 10 includes a seat cushion 12, a seat back 14 pivotally coupled to the seat cushion 12, and a seat base 16 configured to support the seat assembly 10 above a vehicle floor 18. The seat base 16 may include a pair of laterally spaced apart riser brackets 20 directly fixedly coupled to the vehicle floor 18 or fixedly coupled to other components of the seat base 16, such as a track assembly, a height adjustment mechanism, a tilt mechanism, and the like, without altering the scope of the present invention. In addition, the seat assembly 10 includes a swivel mechanism 22 pivotally coupling the seat cushion 12 to the seat base 16. The swivel mechanism 22 allows the seat cushion 12 to be selectively pivoted relative to the seat base 16 between a forward-facing position and a rearward-facing position.

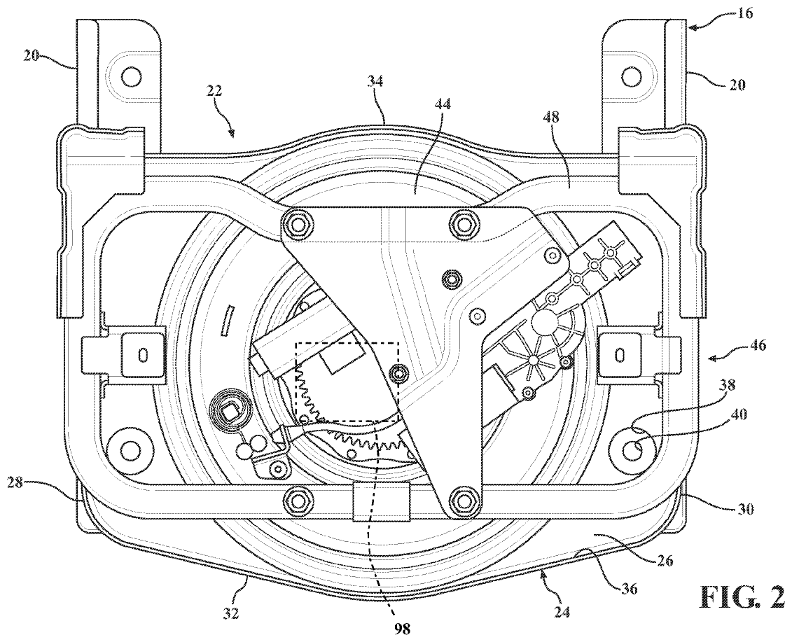

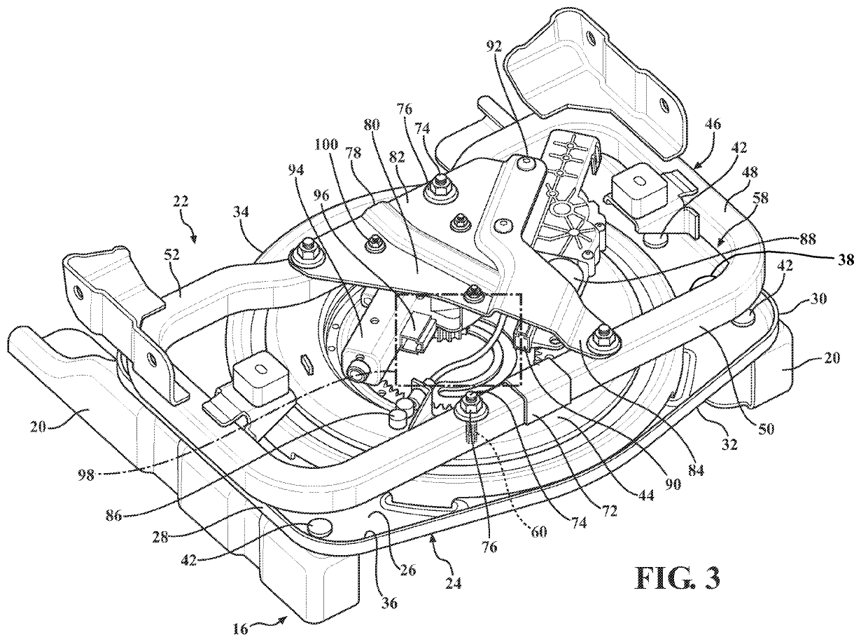

Referring to FIGS. 2 and 3, the swivel mechanism 22 includes a lower plate 24 fixedly coupled to the seat base 16 and configured to provide support for the swivel mechanism 22. The lower plate 24 includes a platform 26 extending between left and right sides 28, 30 and extending between front and rear sides 32, 34. The lower plate 24 also includes a rim 36 extending around an outer perimeter of the platform 26. In addition, the lower plate 24 includes spaced apart clearance holes 38 extending vertically through the platform 26 near the left and right sides 28. 30 and configured to align with lower attachment holes 40 in the riser brackets 20. During assembly, structure attachments 42, such as mechanical fasteners, are inserted through holes (not shown) in the lower plate 24 and the riser brackets 20 to fixedly couple the lower plate 24 to the riser brackets 20. Alternatively, the riser brackets 20 could be welded to the lower plate 24 without altering the scope of the present invention. The swivel mechanism 22 also includes an upper plate 44 rotatably coupled to the lower plate 24 by rollers and/or bearings (not shown) positioned between the lower and upper plates 24, 44 to allow for smooth rotation of the swivel mechanism 22, as is commonly known in the art.

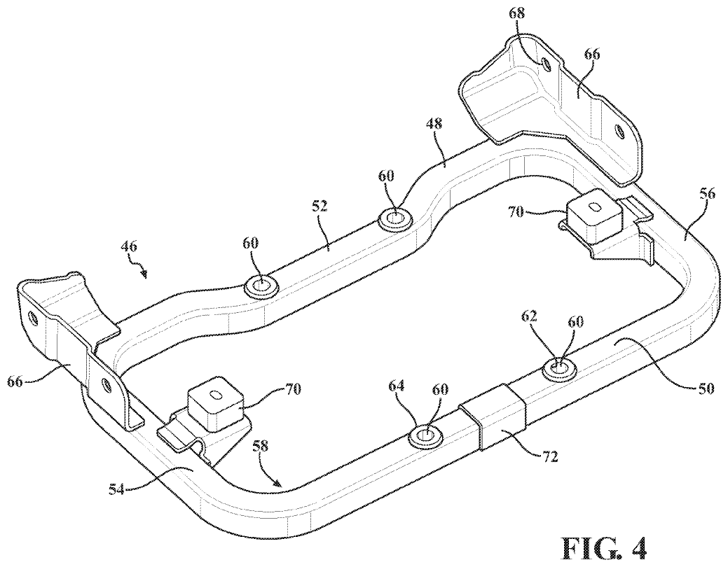

The swivel mechanism 22 includes a modular carrier assembly 46 (hereinafter, “carrier assembly”) comprising a tubular frame 48 configured to support the seat cushion 12. Referring to FIG. 4, the tubular frame 48 includes a front portion 50 spaced longitudinally apart from a rear portion 52. The tubular frame 48 also includes opposing left and right portions 54, 56 extending between the front and rear portions 50, 52. The tubular frame 48 includes an opening 58 extending vertically therethrough and bounded by the left and right portions 54, 56 and the front and rear portions 50, 52. A pair of laterally spaced apart passageways 60 extend vertically through the front and rear portions 50, 52 of the tubular frame 48. The carrier assembly 46 may include one or more of a bushing 62, a washer 64, and the like assembled with each of the passageways 60. The tubular frame 48 has a generally rectangular shape in cross-section. However, it will be appreciated that the cross-sectional shape and the general overall shape of the tubular frame 48 may vary without altering the scope of the present invention. Referring to FIGS. 2 and 3, the clearance holes 38 in the lower plate 24 are vertically accessible through the opening 58 in the tubular frame 48 without requiring rotation of the swivel mechanism 22 away from the forward-facing position. The carrier assembly 46 having a tubular frame 48 allows access to the lower attachment holes 40 in the riser brackets 20 through the opening 58 in the tubular frame 48 and through the clearance holes 38 in the lower plate 24.

Depicted in FIG. 4, the carrier assembly 46 also includes laterally spaced apart seat brackets 66 fixedly coupled to respective left and right portions 54, 56 of the tubular frame 48 and configured to be fixedly coupled to the seat cushion 12 or seat back 14. It will be appreciated that the seat brackets 66 may be fixedly coupled to the rear portion 52 and/or to the front portion 50 without altering the scope of the present invention. The seat brackets 66 include spaced apart mounting holes 68 extending laterally through the seat brackets 66. Referring to FIG. 1, the seat assembly 10 includes mechanical fasteners (not shown) inserted through the mounting holes 68 and into the seat cushion 12 fixedly coupling the seat brackets 66 to the seat cushion 12. In addition, the carrier assembly 46 includes cushion frame support brackets 70 fixedly coupled to the left and right portions 54. 56, respectively, of the tubular frame 48. The cushion frame support brackets 70 are configured to support the cushion frame (not shown) of the seat assembly 10.

Depicted in FIGS. 3 and 4, the carrier assembly 46 may also include a welded reinforcement 72 fixedly coupling the ends of the tubular frame 48. The swivel mechanism 22 also includes bolts 74 fixedly coupling the tubular frame 48 to the upper plate 44. The bolts 74 are inserted through holes (not shown) in the upper plate 44, through respective passageways 60 in the tubular frame 48, and fastened with nuts 76.

Referring to FIG. 3, the carrier assembly 46 may also include a support bracket 78 fixedly coupled to the tubular frame 48 and providing support for certain functional components. The support bracket 78 is a generally triangular-shaped bracket having a central section 80 extending between a rearward section 82 and a forward section 84. The rearward section 82 and the forward section 84 are fixedly coupled to the rear portion 52 and the front portion 50, respectively, of the tubular frame 48. The support bracket 78 is spaced axially between the tubular frame 48 and the nuts 76 with the bolts 74 extending through holes (not shown) in the support bracket 78. It will be appreciated that the general shape of the support bracket 78, the number of bolts 74 attaching the support bracket 78 to the tubular frame 48, and the locations of the passageways 60 in the tubular frame 48 may vary without altering the scope of the present invention.

The swivel mechanism 22 also includes a latching mechanism 86 fixedly coupled to the upper plate 44 and configured to selectively prevent rotation of the upper plate 44 relative to the lower plate 24 when the latching mechanism 86 is in a latched condition. The upper plate 44 is rotatable relative to the lower plate 24 while the latching mechanism 86 is in an unlatched condition. The carrier assembly 46 may also include a release actuator 88 operatively coupled to the latching mechanism 86 and configured to selectively unlatch the latching mechanism 86. The release actuator 88 includes a power connector 90 for attaching a wiring harness (not shown) configured to provide power to the release actuator 88. The release actuator 88 is fixedly coupled to the support bracket 78 by mechanical fasteners 92 with the release actuator 88 supported within the opening 58 in the tubular frame 48.

Also shown in FIG. 3, the carrier assembly 46 may also include a rotation motor 94 operatively coupled to the upper plate 44 and configured to selectively rotate the upper plate 44 relative to the lower plate 24 when the latching mechanism 86 is in the unlatched condition. The rotation motor 94 is fixedly coupled to the support bracket 78 by mechanical fasteners 100 with the rotation motor 94 supported within the opening 58 in the tubular frame 48. In addition, the rotation motor 94 includes a power connector 96 for attaching the wiring harness (not shown) configured to provide power to the rotation motor 94. The release actuator 88 and the rotation motor 94 are examples of functional components that may be integrated within the carrier assembly 46. The opening 58 in the tubular frame 48 provides a wire harness pass-through space 98 in the carrier assembly 46, allowing one or more wiring harnesses (not shown) to be easily connected to the electrical power connectors 90, 96 on the release actuator 88, the rotation motor 94, and the like. The carrier assembly 46 has an open design which provides easy access to make connections to power components and to route wiring harnesses (not shown) through the carrier assembly 46.

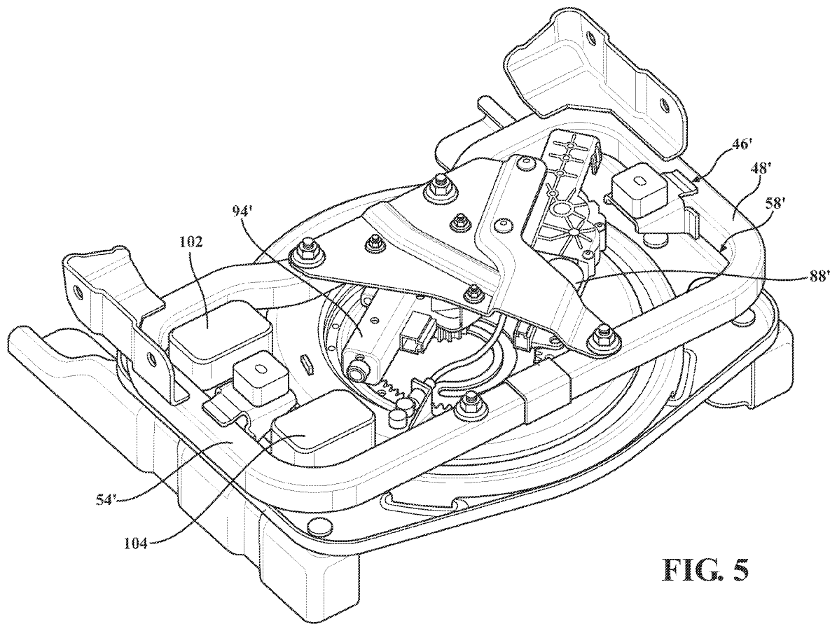

A second embodiment of the carrier assembly 46′ is shown in FIG. 5, where like primed reference numerals represent similar elements as those described above. The second embodiment shown in FIG. 5 includes a heater module 102 and a seat control module 104 in addition to the rotation motor 94′ and the release actuator 88′ shown in FIG. 3. Only significant differences between the two embodiments are reflected in the Figures and the description below. The heater module 102 and the seat control module 104 are electronic control modules (ECU), as is commonly known in the art. The heater module 102 and the seat control module 104 are fixedly coupled to the left portion 54′ of the tubular frame 48′ and at least partially supported within the opening 58′ in the tubular frame 48′. It will be appreciated that the functional components, including the heater module 102 and the seat control module 104 as non-limiting examples, may be fixedly coupled to other locations on the tubular frame 48′ and may include mounting brackets (not shown) without altering the scope of the present invention. In addition, it will be appreciated that carrier assembly 46′ may include other electronic control modules (ECU) without altering the scope of the present invention.

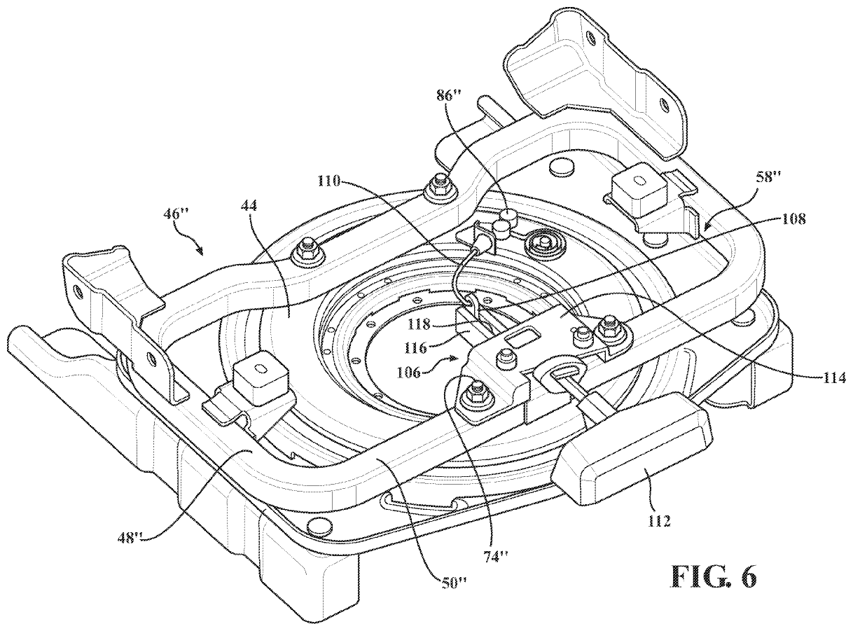

A third embodiment of the carrier assembly 46″ is shown in FIG. 6, where like double primed reference numerals represent similar elements as those described above. The third embodiment shown in FIG. 6 depicts a manual release assembly 106 in place of the release actuator 88 shown in FIG. 3. Only significant differences between the embodiments are reflected in the Figures and the description below. The manual release assembly 106 is configured to manually unlock the latching mechanism 86″. The manual release assembly 106 includes a bar 108 having a proximal end operatively coupled to the latching mechanism 86″ by a cable 110 and a distal end fixedly coupled to a release handle 112. The manual release assembly 106 also includes a handle bracket 114 fixedly coupled to the front portion 50″ of the tubular frame 48″ by spaced apart bolts 74″. In addition, the manual release assembly 106 includes a track 116 fixedly coupled to the handle bracket 114 and including a channel 118 extending longitudinally along the track 116. The bar 108 is slidably coupled to the channel 118 and travels within the handle bracket 114 during actuation of the manual release assembly 106.

As discussed above, the seat assembly 10 of the present invention includes a swivel mechanism 22 comprising a modular carrier assembly 46, 46′. 46″ fixedly coupled to an upper plate 44. The modular carrier assembly 46, 46′, 46″ includes a tubular frame 48, 48′, 48″ having an opening 58, 58′, 58″ extending therethrough and providing a mounting surface for functional components, such as a release actuator 88, 88′, a rotation motor 94. 94′, a heater module 102, a seat control module 104, a manual release assembly 106, seat brackets 66, cushion frame support brackets 70, and the like. In addition, the opening 58, 58′, 58″ in the tubular frame 48, 48′, 48″ provides vertical access to the lower attachment holes 40 in the riser brackets 20 and the clearance holes 38 in the lower plate 24 without requiring rotation of the swivel mechanism 22. The modular carrier assembly 46, 46′, 46″ provides a simplified environment to add, drop, and change functional content from a swivel mechanism 22 for use in high content and low content seat assemblies 10. In addition, the modular carrier assembly 46, 46′, 46″ allows for easy addition, removal, and substitution of various mounting brackets, such as the support bracket 78 and the seat brackets 66.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A seat assembly for an automotive vehicle, the seat assembly comprising:
a seat base with lower attachment holes;
a seat cushion; and
a swivel mechanism comprising a lower plate fixedly coupled to the seat base by a structure attachment, an upper plate rotatably coupled to the lower plate, and a modular carrier assembly fixedly coupled to the upper plate and fixedly coupled to the seat cushion;
wherein the modular carrier assembly comprises a tubular frame fixedly coupled to the upper plate, the tubular frame including a front portion and a rear portion extending between a left portion and a right portion with the tubular frame surrounding around an opening extending vertically therethrough providing vertical access to the lower attachment holes.

2. The seat assembly as set forth in claim 1, wherein:
the modular carrier assembly further comprises laterally spaced apart seat brackets fixedly coupled to the tubular frame and fixedly coupled to the seat cushion.

3. The seat assembly as set forth in claim 2, wherein:
the swivel mechanism further comprises a latching mechanism operatively coupled to the upper plate and configured to selectively prevent rotation of the upper plate relative to the lower plate.

4. The seat assembly as set forth in claim 3, wherein:
the modular carrier assembly further comprises a manual release assembly comprising a handle bracket fixedly coupled to the tubular frame and a release handle slidably coupled to the handle bracket and operatively coupled to the latching mechanism; and
the manual release assembly is configured to selectively unlatch the latching mechanism allowing rotation of the upper plate relative to the lower plate.

5. The seat assembly as set forth in claim 3, wherein:
the modular carrier assembly further comprises a support bracket fixedly coupled to the tubular frame and a release actuator fixedly coupled to the support bracket and operatively coupled to the latching mechanism; and
the release actuator is configured to selectively unlatch the latching mechanism allowing rotation of the swivel mechanism.

6. The seat assembly as set forth in claim 5, wherein:
the modular carrier assembly further comprises a rotation motor fixedly coupled to the support bracket and operatively coupled to the upper plate; and
the rotation motor is configured to selectively rotate the upper plate relative to the lower plate.

7. The seat assembly as set forth in claim 6, wherein:
the rotation motor and the release actuator are supported by the support bracket and positioned at least partially within the opening in the tubular frame.

8. The seat assembly as set forth in claim 7, wherein:
the modular carrier assembly further comprises a wire harness pass-through space within the opening in the tubular frame providing access to power connectors on the rotation motor and the release actuator.

9. The seat assembly as set forth in claim 8, wherein:
the modular carrier assembly further comprises a heater module fixedly coupled to the tubular frame.

10. The seat assembly as set forth in claim 8, wherein:
the modular carrier assembly further comprises a seat control module fixedly coupled to the tubular frame.

11. The seat assembly as set forth in claim 2, wherein:
the lower attachment holes are accessible through clearance holes in the lower plate and through the opening in the tubular frame while the swivel mechanism is in a forward-facing position.

12. A modular carrier assembly for use in an automotive seat assembly having a swivel mechanism, the modular carrier assembly comprising:
a tubular frame including a front portion and a rear portion extending between a left portion and a right portion with the tubular frame surrounding an opening extending vertically therethrough;
laterally spaced apart seat brackets fixedly coupled to the left portion and the right portion, respectively, of the tubular frame; and
a functional component fixedly coupled to the tubular frame.

13. The modular carrier assembly as set forth in claim 12, wherein:
the functional component comprises a manual release assembly fixedly coupled to the tubular frame.

14. The modular carrier assembly as set forth in claim 12, wherein:
the functional component comprises an electronic control module fixedly coupled to the tubular frame.

15. The modular carrier assembly as set forth in claim 14, wherein:
the electronic control module comprises a heater module.

16. The modular carrier assembly as set forth in claim 14, wherein:
the electronic control module comprises a seat control module.

17. The modular carrier assembly as set forth in claim 12, further comprising:
a support bracket fixedly coupled to the front portion and the rear portion of the tubular frame.

18. The modular carrier assembly as set forth in claim 17, wherein:
the functional component comprises a release actuator fixedly coupled to the support bracket and positioned at least partially within the opening in the tubular frame.

19. The modular carrier assembly as set forth in claim 18, wherein:
the functional component further comprises a rotation motor fixedly coupled to the support bracket and positioned at least partially within the opening in the tubular frame.
